(19) United States
(12) Patent Application Publication
(10) Pub. No.: US 2024/0109532 A1
(43) Pub. Date: Apr. 4, 2024

(54) MANAGING PARKING MANEUVERS FOR AUTONOMOUS VEHICLES

(71) Applicant: Waymo LLC, Mountain View, CA (US)

(72) Inventors: Ianis Bougdal-Lambert, Seattle, WA (US); Mishika Vora, Hayward, CA (US); Jakob Robert Zwiener, San Francisco, CA (US)

(21) Appl. No.: 18/465,653

(22) Filed: Sep. 12, 2023

Related U.S. Application Data
(60) Provisional application No. 63/411,421, filed on Sep. 29, 2022.

(51) Int. Cl. B60W 30/06; B60W 60/00

(52) U.S. Cl. CPC B60W 30/06; B60W 60/001; B60W 2720/24

(57) ABSTRACT

Aspects of the disclosure relate to managing parking maneuvers for autonomous vehicles. For instance, a vehicle may be stopped at a parking location. A distance between the autonomous vehicle and a road edge at the parking location may be determined. Based on the distance, a plurality of points corresponding to parking locations at various distances from the road edge may be sampled. For each of the plurality of points, a trajectory for the autonomous vehicle may be determined. One of the determined trajectories may be selected. The autonomous vehicle closer to the road edge using the selected one of the determined trajectories.

### CROSS REFERENCE TO RELATED APPLICATIONS

The present application claims the benefit of the filing date of U.S. Provisional Application No. 63/411,421, filed Sep. 29, 2022, the entire disclosure of which is incorporated by reference herein.

### BACKGROUND

Autonomous vehicles, for instance vehicles that may not require a human driver, can be used to aid in the transport of passengers or items from one location to another. Such vehicles may operate in a fully autonomous mode where passengers may provide some initial input, such as a pickup or destination location, and the autonomous vehicle maneuvers itself to that location. Autonomous vehicles are equipped with various types of sensors in order to detect objects in the surroundings. For example, autonomous vehicles may include sonar, radar, camera, lidar, and other devices that scan, generate and/or record data about the autonomous vehicle's surroundings in order to enable the autonomous vehicle to plan trajectories to maneuver itself through the surroundings.

### BRIEF SUMMARY

Aspects of the disclosure provide a method. The method includes: stopping, by one or more processors, an autonomous vehicle at a parking location; determining, by the one or more processors, a distance between the autonomous vehicle and a road edge at the parking location; based on the distance, sampling, by the one or more processors, a plurality of points corresponding to parking locations at various distances from the road edge; determining, by the one or more processors, for each of the plurality of points, a trajectory for the autonomous vehicle; selecting, by the one or more processors, one of the determined trajectories; and maneuvering, by the one or more processors, the autonomous vehicle closer to the road edge using the selected one of the determined trajectories.

In one example, determining the distance includes determining a farthest distance between the road edge and a tire of the autonomous vehicle that is (i) farthest from the road edge and (ii) on a side of the autonomous vehicle that is oriented towards the road edge. In another example, determining the determined trajectories is based on a comparison of the distance to a threshold maximum distance. In another example, the plurality of points is sampled from a minimum value from the road edge to a threshold maximum distance from the road edge. In another example, the method also includes, enabling, by the one or more processors, the autonomous vehicle to engage a set of planning behaviors, and wherein the sampling is in response to engaging the set of planning behaviors. In this example, engaging the set of planning behaviors includes switching from a forward planning system of the autonomous vehicle to a maneuver planning system of the autonomous vehicle in order to determine the determined trajectories. In addition or alternatively, engaging the set of planning behaviors includes enabling a forward planning system of the autonomous vehicle to plan trajectories that allow for maneuvers in reverse. In this example, the set of planning behaviors include constraints for reducing time spent in an adjacent driving lane. In addition or alternatively, the set of planning behaviors include constraints for reducing distance maneuvered in an adjacent driving lane. In addition or alternatively, the set of planning behaviors include constraints for reducing time spent maneuvering in reverse. In addition or alternatively, the set of planning behaviors include constraints for reducing distance maneuvered in reverse. In another example, the method also includes determining for each determined trajectory a cost based at least in part on a shortest distance between the road edge and a point of the plurality of points for the determined trajectory, and wherein the selecting the one of the determined trajectories is based on the determined costs. In this example, determining the cost for each determined trajectory is based on expected time spent in an adjacent driving lane. In addition or alternatively, determining the cost for each determined trajectory is based on expected time spent maneuvering in reverse. In addition or alternatively, determining the cost for each determined trajectory is based on expected distance driven in an adjacent driving lane. In addition or alternatively, determining the cost for each determined trajectory is based on expected distance driven in reverse. In addition or alternatively, determining the cost for each determined trajectory is based on whether that determined trajectory extends more than a threshold distance into an adjacent driving lane. In another example, the method also includes, discarding a second of the determined trajectories from the determined trajectories based on whether the second of the determined trajectories extends more than a threshold distance into an adjacent driving lane.

Another aspect of the disclosure provides a system including one or more processors configured to: stop an autonomous vehicle at a parking location; determine a distance between the autonomous vehicle and a road edge at the parking location; based on the distance, sample a plurality of points corresponding to parking locations at various distances from the road edge; determine for each of the plurality of points, a trajectory for the autonomous vehicle; select one of the determined trajectories; and maneuver the autonomous vehicle closer to the road edge using the selected one of the determined trajectories.

In one example, the system also includes the vehicle.

### BRIEF DESCRIPTION OF THE DRAWINGS

FIG. 1 is a functional diagram of an example vehicle in accordance with an exemplary embodiment.

FIG. 2 is an example of map information in accordance with aspects of the disclosure.

FIG. 3A-3B are example external views of a vehicle in accordance with aspects of the disclosure.

FIG. 4 is a pictorial diagram of an example system in accordance with aspects of the disclosure.

FIG. 5 is a functional diagram of the system of FIG. 4 in accordance with aspects of the disclosure.

FIG. 6 is an example of an autonomous vehicle and data depicted with respect to a geographic area in accordance with aspects of the disclosure.

FIG. 7 is another example of an autonomous vehicle and data depicted with respect to a geographic area in accordance with aspects of the disclosure.

FIG. 8 is another example of an autonomous vehicle and data depicted with respect to a geographic area in accordance with aspects of the disclosure.

FIG. 9 is another example of an autonomous vehicle and data depicted with respect to a geographic area in accordance with aspects of the disclosure.

FIG. 10 is an example of a tire of an autonomous vehicle and data depicted with respect to a geographic area in accordance with aspects of the disclosure.

FIG. 11 is another example of an autonomous vehicle and data depicted with respect to a geographic area in accordance with aspects of the disclosure.

FIG. 12 is another example of an autonomous vehicle and data depicted with respect to a geographic area in accordance with aspects of the disclosure.

FIG. 13 is a flow diagram in accordance with aspects of the disclosure

### DETAILED DESCRIPTION

### Overview

The technology relates to managing parking maneuvers for autonomous vehicles in certain situations, such as when an autonomous vehicle is not located within a desired distance of a road edge or curb when parking. This may involve planning and following trajectories which require the autonomous vehicle to maneuver in reverse. In many instances, a forward planning system may be used for nominal driving in order to allow the autonomous vehicle to plan trajectories to follow a route generated by a routing system. For safety and ease of implementation, the forward planner may be limited to planning trajectories which require the autonomous vehicle to move forward (or stop) and do not allow the autonomous vehicle to move in reverse. However, if an autonomous vehicle is stopped to park and is too far from a road edge or curb, the forward planning system may not be able to get closer unless it is able to plan trajectories that involve reversing maneuvers.

Some autonomous vehicles may utilize different planning systems for such specialized maneuvers. In some embodiments a forward planning system may be used for nominal driving situations in order to allow the autonomous vehicle to plan trajectories in order to follow a route generated by a routing system. For safety and ease of implementation, the forward planning system may be configured to generate planning trajectories that limit the autonomous vehicle to move forward or to stop only, and may eliminate other trajectories involving other movements, such as a trajectory for the autonomous vehicle to move in reverse. In some embodiments, a specialized planning system, such as a maneuver planning system, may be utilized for situations where the autonomous vehicle needs to maneuver into a space constrained spot, such as moving closer to a curb, for example, when parking, or in another example, when making room for an emergency vehicle. In some embodiments, utilizing different specialized systems, such as a forward planning system and a maneuver planning system, in an integrated system enables access to a wide range of trajectories having different geometries (e.g., forward-path trajectories such as lane changes and reverse-path trajectories such as multi-point turns), while at the same time requiring much simpler reasoning or processing of time and speed by each subsystem; a maneuver planning system, for example, does not need to be capable of performing more complex maneuvers, such as lane changes, which a forward planning system can handle.

In an example, in pulling over into a parking location, the forward planning system may plan trajectories to cause the autonomous vehicle to pull into the parking location and stop the autonomous vehicle accordingly, such as once the vehicle has pulled into the location. The forward planning system may also be utilized to maneuver the autonomous vehicle into the parking location by causing the autonomous vehicle to move through one or more reverse motions. During the maneuvering under the maneuver planning system, the autonomous vehicle may be controlled to stop, and once stopped, the autonomous vehicle may determine the distance between the autonomous vehicle and the adjacent road edge. The distance to the road edge or curb may be defined as the shortest distance between the road edge (or distance between the curb) and the farthest of the autonomous vehicle's tires on a side of the autonomous vehicle that is oriented towards or facing the road edge or curb.

Based on this distance between the road edge and the autonomous vehicle's tire, the autonomous vehicle may engage or execute a set of planning behaviors that allow the autonomous vehicle to maneuver in reverse in order to improve the position and orientation of the autonomous vehicle relative to the road edge or curb. Maneuver planning system may determine if the autonomous vehicle is within a threshold maximum distance of the road edge or curb, the autonomous vehicle may remain stopped (e.g., without further maneuvering) in order to allow passengers to enter or exit, load or unload goods, etc. without additional delays. However, if the autonomous vehicle is not within the threshold maximum distance, the autonomous vehicle may attempt to maneuver itself closer to the road edge or curb. To do so, the set of planning behaviors may be engaged or unlocked in order to allow the forward planning system or maneuver planning system to plan trajectories that cause the autonomous vehicle to maneuver in reverse.

The engaged set of planning behaviors may be used to maneuver the autonomous vehicle closer to the road edge. In some instances, the forward planning system may engage or “unlock” the set of planning behaviors in order to allow the forward planning system to plan trajectories that cause the autonomous vehicle to maneuver in reverse. In other instances, the maneuver planning system may be utilized to maneuver the autonomous vehicle closer to a curb.

In addition to the aforementioned, the set of planning behaviors may involve first sampling points along the road edge or curb at various distances between the road edge or curb and some point on the autonomous vehicle. For example, these distances may range from a minimum value to the threshold maximum distance. The minimum value may be zero or may be defined based on the maneuvering capabilities of the autonomous vehicles.

The locations of each of these sampled points may be input into the forward planning system or maneuver planning system as destinations in order to plan a trajectory for the autonomous vehicle to reach the locations of each of these points. The forward planning system or maneuver planning system may therefore output a plurality of trajectories. As with typical planning approaches described herein, the trajectory with the lowest overall cost may be selected by the forward planning system or maneuver planning system and published to the other systems of the autonomous vehicle in order to cause the autonomous vehicle to follow the selected trajectory. For instance, the trajectory with the lowest cost may enable the autonomous vehicle to move closer to the road edge or curb. Once the location of the selected point has been reached, the autonomous vehicle may again be stopped to allow passengers to enter or exit, load or unload goods, etc. without further maneuvering in order to avoid any unnecessary delays.

The features described herein may allow for managing parking maneuvers for autonomous vehicles in certain situations, such as when an autonomous vehicle is not located within a desired distance of a road edge or curb. In such situations, the autonomous vehicle may enable or unlock a set of planning behaviors which allow the autonomous vehicle to maneuver closer to the road edge or curb which may require the autonomous vehicle to maneuver in reverse. By doing so, this may improve safety by reducing the amount of time the autonomous vehicle is within a driving lane adjacent to a location where the autonomous vehicle is attempting to stop. Moreover, the approach described herein may allow the autonomous vehicle to initially pull forward into the location and avoid a typical parallel parking maneuver which requires the autonomous vehicle to stop completely in a driving lane adjacent to the location and then reverse into the location while at the same time minimizes the time to complete a pullover in cases where no further maneuvering is required. Moreover, in situations in which the autonomous vehicle engages in a typical parallel parking maneuver, the autonomous vehicle may be able to pull into smaller pullover locations (e.g., between two other parked vehicles) and closer to the road edge.

### Example Systems

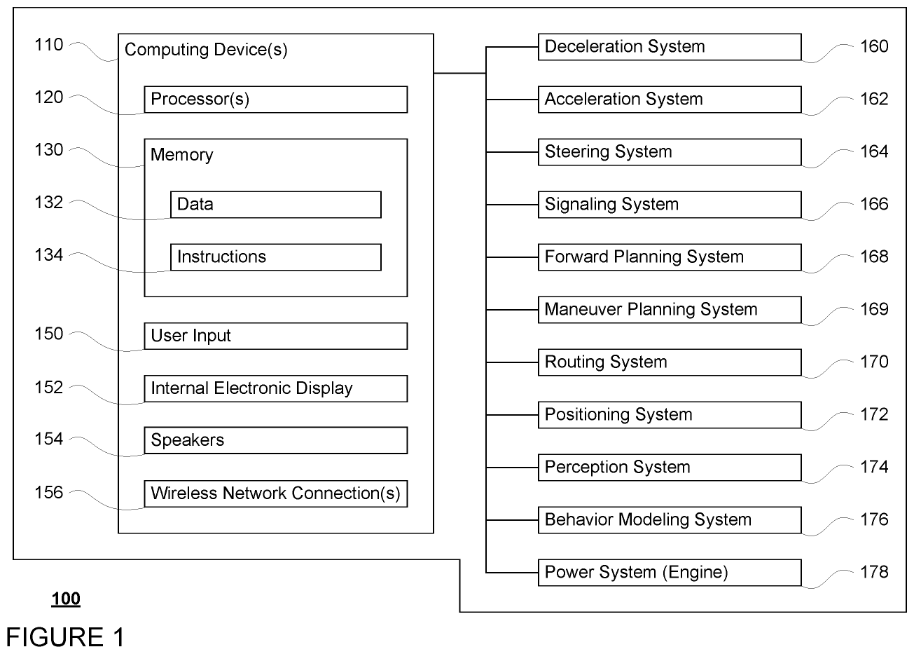

As shown in FIG. 1, an autonomous vehicle 100 in accordance with one aspect of the disclosure includes various components. Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. A vehicle may also operate in one or more autonomous driving modes including, for example, a semi or partially autonomous driving mode in which a person exercises some amount of direct or remote control over driving operations, or a fully autonomous driving mode in which the autonomous vehicle handles the driving operations without direct or remote control by a person. These vehicles may be known by different names including, for example, autonomously driven vehicles, self-driving vehicles, and so on.

The U.S. National Highway Traffic Safety Administration (NHTSA) and the Society of Automotive Engineers (SAE) have each identified different levels to indicate how much, or how little, a vehicle controls the driving, although different organizations may categorize the levels differently. Moreover, such classifications may change (e.g., be updated) overtime.

As described herein, in a semi or partially autonomous driving mode, even though the autonomous vehicle assists with one or more driving operations (e.g., steering, braking and/or accelerating to perform lane centering, adaptive cruise control or emergency braking), the human driver is expected to be situationally aware of the autonomous vehicle's surroundings and supervise the assisted driving operations. Here, even though the autonomous vehicle may perform all driving tasks in certain situations, the human driver is expected to be responsible for taking control as needed.

In contrast, in a fully autonomous driving mode, the control system of the autonomous vehicle performs all driving tasks and monitors the driving environment. This may be limited to certain situations such as operating in a particular service region or under certain time or environmental restrictions, or may encompass driving under all conditions without limitation. In a fully autonomous driving mode, a person is not expected to take over control of any driving operation.

Unless indicated otherwise, the architectures, components, systems and methods described herein can function in a semi or partially autonomous driving mode, or a fully-autonomous driving mode.

While certain aspects of the disclosure are particularly useful in connection with specific types of vehicles, the autonomous vehicle may be any type of vehicle including, but not limited to, cars, trucks (e.g., garbage trucks, tractor-trailers, pickup trucks, etc.), motorcycles, buses, recreational vehicles, street cleaning or sweeping vehicles, etc. the autonomous vehicle may have one or more computing devices, such as computing device 110 containing one or more processors 120, memory 130 and other components typically present in general purpose computing devices.

The memory 130 stores information accessible by the one or more processors 120, including data 132 and instructions 134 that may be executed or otherwise used by the processor 120. The memory 130 may be of any type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processors 120 may be any conventional processors, such as commercially available CPUs or GPUs. Alternatively, the one or more processors may include a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing devices 110 may include all of the components normally used in connection with a computing device such as the processor and memory described above as well as a user input 150 (e.g., one or more of a button, mouse, keyboard, touch screen and/or microphone), various electronic displays (e.g., a monitor having a screen or any other electrical device that is operable to display information), and speakers 154 to provide information to a passenger of the autonomous vehicle 100 or others as needed. For example, electronic display 152 may be located within a cabin of autonomous vehicle 100 and may be used by computing devices 110 to provide information to passengers within the autonomous vehicle 100.

Computing devices 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

Computing devices 110 may be part of an autonomous control system for the autonomous vehicle 100 and may be capable of communicating with various components of the autonomous vehicle in order to control the autonomous vehicle in an autonomous driving mode. For example, returning to FIG. 1, computing devices 110 may be in communication with various systems of autonomous vehicle 100, such as deceleration system 160, acceleration system 162, steering system 164, signaling system 166, forward planning system 168, maneuver planning system 169, routing system 170, positioning system 172, perception system 174, behavior modeling system 176, and power system 178 in order to control the movement, speed, etc. of autonomous vehicle 100 in accordance with the instructions 134 of memory 130 in the autonomous driving mode.

As an example, computing devices 110 may interact with deceleration system 160 and acceleration system 162 in order to control the speed of the autonomous vehicle. Similarly, steering system 164 may be used by computing devices 110 in order to control the direction of autonomous vehicle 100. For example, if autonomous vehicle 100 is configured for use on a road, such as a car or truck, steering system 164 may include components to control the angle of wheels to turn the autonomous vehicle. Computing devices 110 may also use the signaling system 166 in order to signal the autonomous vehicle's intent to other drivers or vehicles, for example, by lighting turn signals or brake lights when needed.

Routing system 170 may be used by computing devices 110 in order to generate a route to a destination using map information. Forward planning system 168 may be used by computing device 110 in order to generate short-term trajectories that allow the autonomous vehicle to follow routes generated by the routing system. In this regard, the forward planning system 168 and/or routing system 166 may store detailed map information, e.g., pre-stored, highly detailed maps identifying a road network including the shape and elevation of roadways, lane lines, intersections, crosswalks, speed limits, traffic signals, buildings, signs, real time traffic information (updated as received from a remote computing device), pullover spots, vegetation, or other such objects and information.

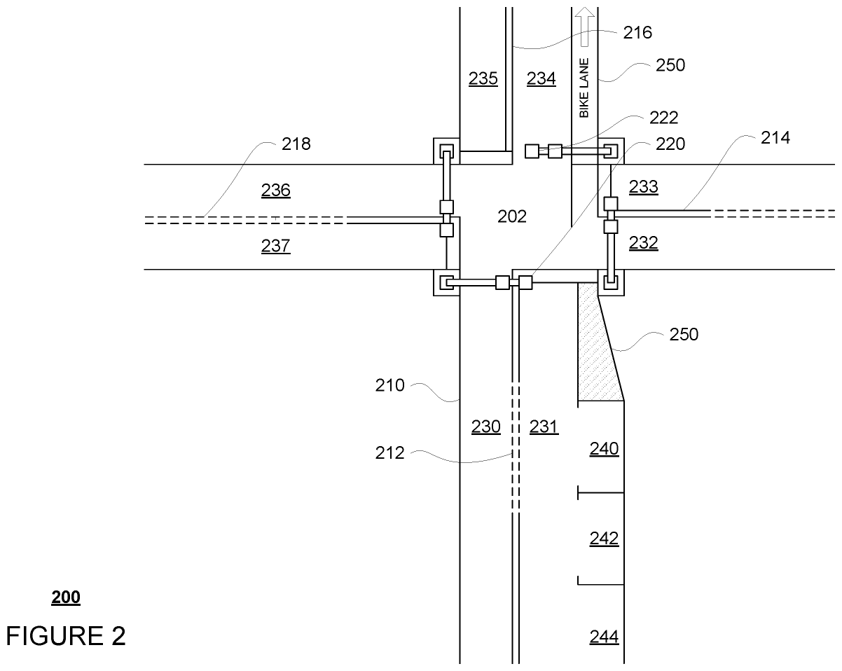

FIG. 2 is an example of map information 200 for a section of roadway including intersection 202. The map information 200 may be a local version of the map information stored in the memory 130 of the computing devices 110. In this example, the map information 200 includes information identifying the shape, location, and other characteristics of lane lines 210, 212, 214, 216, 218 which define the shape and location of lanes 230, 231, 232, 233, 234, 235, 236, 237. The map information may also store information about the location, shape and configuration of traffic controls such as traffic signal lights 220, 222 as well as stop signs, yield signs, and other signs (not shown). The map information may also include other information that allows the computing devices 110 to determine whether the autonomous vehicle has the right of way to complete a particular maneuver (i.e., complete a turn or cross a lane of traffic or intersection).

In addition, the map information may include additional details such as the characteristics (e.g., shape, location, configuration etc.) of traffic controls including traffic signal lights (such as traffic signal lights 220, 222), signs (such as stop signs, yield signs, speed limit signs, road signs, and so on), crosswalks, sidewalks, curbs, buildings or other monuments, etc. For instance, as shown in FIG. 2, the map information identifies the shape and location of parking locations 240, 242, 244 where the autonomous vehicle may stop to wait, pickup, and/or drop off passengers and/or goods and no parking zone 250.

The map information may be configured as a roadgraph. The roadgraph may include a plurality of graph nodes and edges representing features such as crosswalks, traffic lights, road signs, road or lane segments, etc., that together make up the road network of the map information. Each edge is defined by a starting graph node having a specific geographic location (e.g., latitude, longitude, altitude, etc.), an ending graph node having a specific geographic location (e.g., latitude, longitude, altitude, etc.), and a direction. This direction may refer to a direction the autonomous vehicle 100 must be moving in in order to follow the edge (i.e., a direction of traffic flow). The graph nodes may be located at fixed or variable distances. For instance, the spacing of the graph nodes may range from a few centimeters to a few meters and may correspond to the speed limit of a road on which the graph node is located. In this regard, greater speeds may correspond to greater distances between graph nodes. The edges may represent driving along the same lane or changing lanes. Each node and edge may have a unique identifier, such as a latitude and longitude location of the node or starting and ending locations or nodes of an edge. In addition to nodes and edges, the map may identify additional information such as types of maneuvers required at different edges as well as which lanes are drivable.

The routing system 166 may use the aforementioned map information to determine a route from a current location (e.g., a location of a current node) to a destination. Routes may be generated using a cost-based analysis which attempts to select a route to the destination with the lowest cost. Costs may be assessed in any number of ways such as time to the destination, distance traveled (each edge may be associated with a cost to traverse that edge), types of maneuvers required, convenience to passengers or the autonomous vehicle, etc. Each route may include a list of a plurality of nodes and edges which the autonomous vehicle can use to reach the destination. Routes may be recomputed periodically as the autonomous vehicle travels to the destination.

The map information used for routing may be the same or a different map as that used for planning trajectories. For example, the map information used for planning routes not only requires information on individual lanes, but also the nature of lane boundaries (e.g., solid white, dash white, solid yellow, etc.) to determine where lane changes are allowed. However, unlike the map used for planning trajectories, the map information used for routing need not include other details such as the locations of crosswalks, traffic lights, stop signs, etc., though some of this information may be useful for routing purposes. For example, between a route with a large number of intersections with traffic controls (such as stop signs or traffic signal lights) versus one with no or very few traffic controls, the latter route may have a lower cost (e.g., because it is faster) and therefore be preferable.

Positioning system 170 may be used by computing devices 110 in order to determine the autonomous vehicle's relative or absolute position on a map or on the earth. For example, the positioning system 170 may include a GPS receiver to determine the device's latitude, longitude and/or altitude position. Other location systems such as laser-based localization systems, inertial-aided GPS, or camera-based localization may also be used to identify the location of the autonomous vehicle. The location of the autonomous vehicle may include an absolute geographical location, such as latitude, longitude, and altitude, a location of a node or edge of the roadgraph as well as relative location information, such as location relative to other cars immediately around it, which can often be determined with less noise than the absolute geographical location.

The positioning system 172 may also include other devices in communication with computing devices 110, such as an accelerometer, gyroscope or another direction/speed detection device to determine the direction and speed of the autonomous vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

The perception system 174 also includes one or more components for detecting objects external to the autonomous vehicle such as other road users (vehicles, pedestrians, bicyclists, etc.) obstacles in the roadway, traffic signals, signs, trees, buildings, etc. For example, the perception system 174 may include Lidars, sonar, radar, cameras, microphones and/or any other detection devices that generate and/or record data which may be processed by the computing devices of computing devices 110. In the case where the autonomous vehicle is a passenger vehicle such as a minivan or car, the autonomous vehicle may include Lidar, cameras, and/or other sensors mounted on or near the roof, fenders, bumpers or other convenient locations.

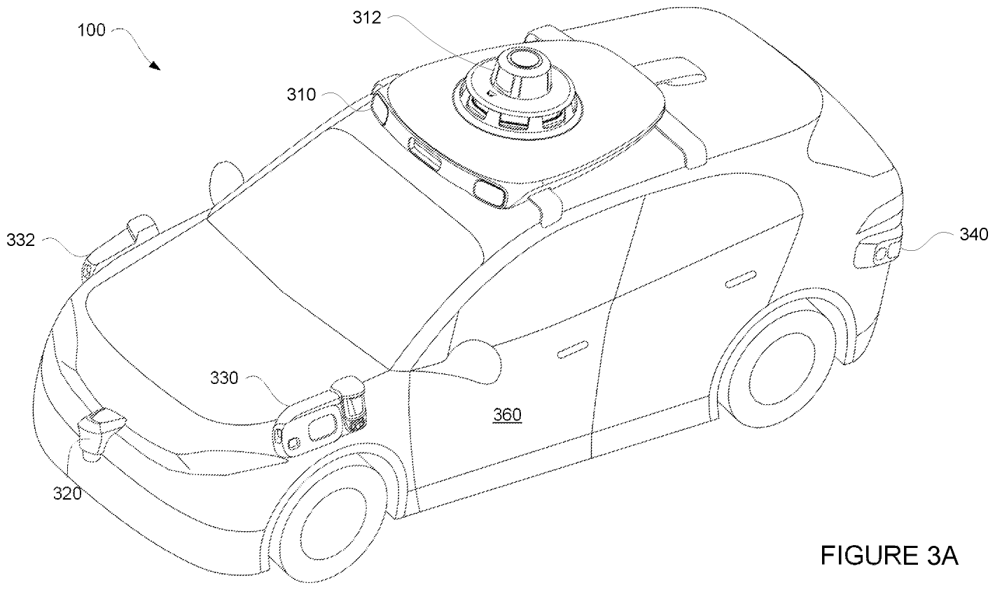

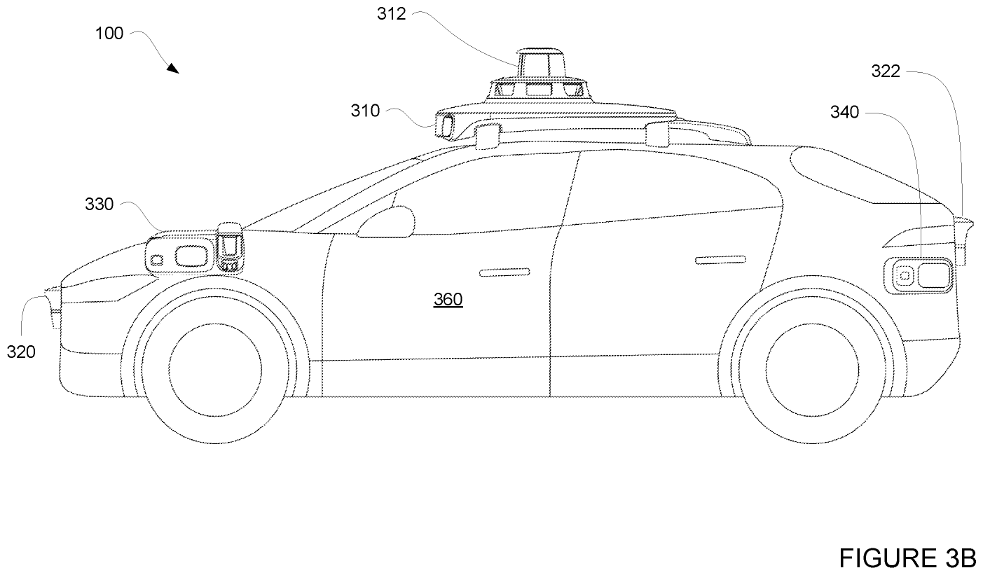

For instance, FIGS. 3A-3B are an example external views of autonomous vehicle 100. In this example, roof-top housing 310 and upper housing 312 may include a Lidar sensor as well as various cameras and radar units. Upper housing 312 may include any number of different shapes, such as domes, cylinders, “cake-top” shapes, etc. In addition, housing 320, 322 (shown in FIG. 3B) located at the front and rear ends of autonomous vehicle 100 and housings 330, 332 on the driver's and passenger's sides of the autonomous vehicle may each store a Lidar sensor and, in some instances, one or more cameras. For example, housing 330 is located in front of driver door 360. Autonomous vehicle 100 also includes a housing 340 for radar units and/or cameras located on the driver's side of the autonomous vehicle 100 proximate to the rear fender and rear bumper of autonomous vehicle 100. Another corresponding housing (not shown may also arranged at the corresponding location on the passenger's side of the autonomous vehicle 100. Additional radar units and cameras (not shown) may be located at the front and rear ends of autonomous vehicle 100 and/or on other positions along the roof or roof-top housing 310.

Computing devices 110 may be capable of communicating with various components of the autonomous vehicle in order to control the movement of autonomous vehicle 100 according to primary vehicle control code of memory of computing devices 110. For example, returning to FIG. 1, computing devices 110 may include various computing devices in communication with various systems of autonomous vehicle 100, such as deceleration system 160, acceleration system 162, steering system 164, signaling system 166, forward planning system 168, routing system 170, positioning system 172, perception system 174, behavior modeling system 176, and power system 178 (i.e. the autonomous vehicle's engine or motor) in order to control the movement, speed, etc. of autonomous vehicle 100 in accordance with the instructions 134 of memory 130.

The various systems of the autonomous vehicle may function using autonomous vehicle control software in order to determine how to control the autonomous vehicle. As an example, a perception system software module of the perception system 174 may use sensor data generated by one or more sensors of an autonomous vehicle, such as cameras, Lidar sensors, radar units, sonar units, etc., to detect and identify objects and their characteristics. These characteristics may include location, type, heading, orientation, speed, acceleration, change in acceleration, size, shape, etc.

In some instances, characteristics may be input into a behavior prediction system software module of the behavior modeling system 176 which uses various behavior models based on object type to output one or more behavior predictions or predicted trajectories for a detected object to follow into the future (e.g., future behavior predictions or predicted future trajectories). In this regard, different models may be used for different types of objects, such as pedestrians, bicyclists, vehicles, etc. The behavior predictions or predicted trajectories may be a list of positions and orientations or headings (e.g., poses) as well as other predicted characteristics such as speed, acceleration or deceleration, rate of change of acceleration or deceleration, etc.

In other instances, the characteristics from the perception system 174 may be put into one or more detection system software modules, such as a traffic light detection system software module configured to detect the states of known traffic signals, construction zone detection system software module configured to detect construction zones from sensor data generated by the one or more sensors of the autonomous vehicle as well as an emergency vehicle detection system configured to detect emergency vehicles from sensor data generated by sensors of the autonomous vehicle. Each of these detection system software modules may use various models to output a likelihood of a construction zone or an object being an emergency vehicle.

Detected objects, predicted trajectories, various likelihoods from detection system software modules, the map information identifying the autonomous vehicle's environment, position information from the positioning system 170 identifying the location and orientation of the autonomous vehicle, a destination location or node for the autonomous vehicle as well as feedback from various other systems of the autonomous vehicle may be input into a planning system software module of the forward planning system 168. The forward planning system 168 may use this input to generate planned trajectories for the autonomous vehicle to follow for some brief period of time into the future based on a route generated by a routing module of the routing system 170. Each planned trajectory may provide a planned path and other instructions for an autonomous vehicle to follow for some brief period of time into the future, such as 10 seconds or more or less. In this regard, the trajectories may define the specific characteristics of acceleration, deceleration, speed, direction, etc. to allow the autonomous vehicle to follow the route towards reaching a destination. A control system software module of computing devices 110 may be configured to control movement of the autonomous vehicle, for instance by controlling braking, acceleration and steering of the autonomous vehicle, in order to follow a trajectory.

In some situations, a specialized planning system or the maneuver planning system 169 may be used as an alternative to the forward planning system 168 in order to enable the autonomous vehicle to perform specialized maneuvers. For example, the forward planning system 168 may be used for nominal driving in order to allow the autonomous vehicle to plan trajectories in order to follow a route generated by a routing system. For safety and ease of implementation, the forward planning system 168 may be limited to planning trajectories which require the autonomous vehicle to move forward (or stop) and do not allow the autonomous vehicle to move in reverse. In this regard, the maneuver planning system 169 may be utilized for situations in which the autonomous vehicle needs to maneuver in reverse. This may allow for a simplified system which can utilize different geometries (e.g., including those for reversing such as for multi-point turns or turning the autonomous vehicle's wheels while stationary), while at the same time requires much simpler “reasoning” or processing of time and speed as the maneuver planning system does not need to be capable of performing more complex maneuvers such as lane changes in traffic.

In some instances, the maneuver planning system and forwarding planning system may actually each be software modules of a larger planning system that are utilized at different times in accordance with the features described herein.

The computing devices 110 may control the autonomous vehicle in one or more of the autonomous driving modes by controlling various components. For instance, by way of example, computing devices 110 may navigate the autonomous vehicle to a destination location completely autonomously using data from the detailed map information and forward planning system 168. Computing devices 110 may use the positioning system 170 to determine the autonomous vehicle's location and perception system 174 to detect and respond to objects when needed to reach the location safely. Again, in order to do so, computing device 110 and/or forward planning system 168 may generate trajectories and cause the autonomous vehicle to follow these trajectories, for instance, by causing the autonomous vehicle to accelerate (e.g., by supplying fuel or other energy to the engine or power system 178 by acceleration system 162), decelerate (e.g., by decreasing the fuel supplied to the engine or power system 178, changing gears, and/or by applying brakes by deceleration system 160), change direction (e.g., by turning the front or rear wheels of autonomous vehicle 100 by steering system 164), and signal such changes (e.g., by lighting turn signals) using the signaling system 166. Thus, the acceleration system 162 and deceleration system 160 may be a part of a drivetrain that includes various components between an engine of the autonomous vehicle and the wheels of the autonomous vehicle. Again, by controlling these systems, computing devices 110 may also control the drivetrain of the autonomous vehicle in order to maneuver the autonomous vehicle autonomously.

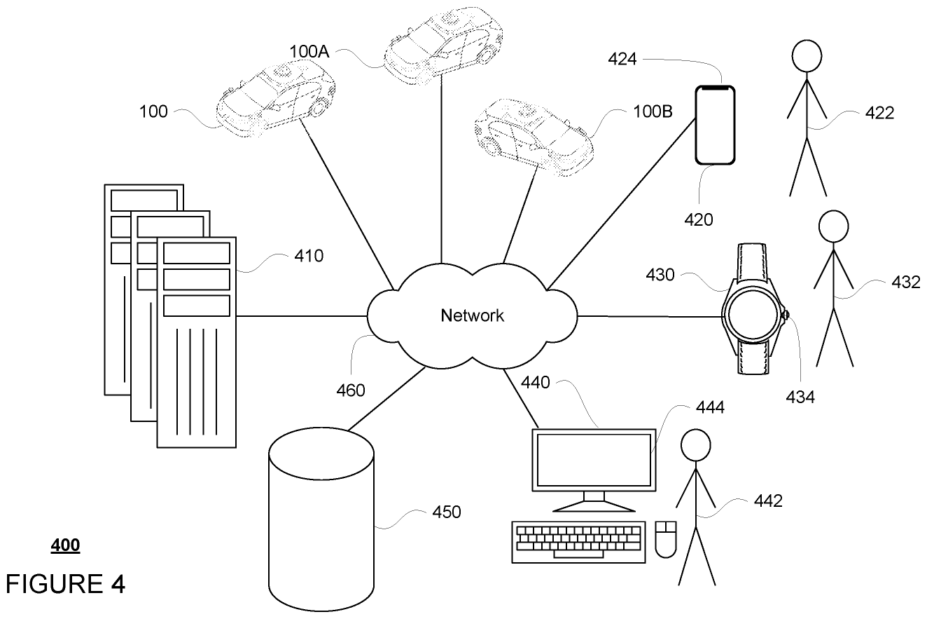

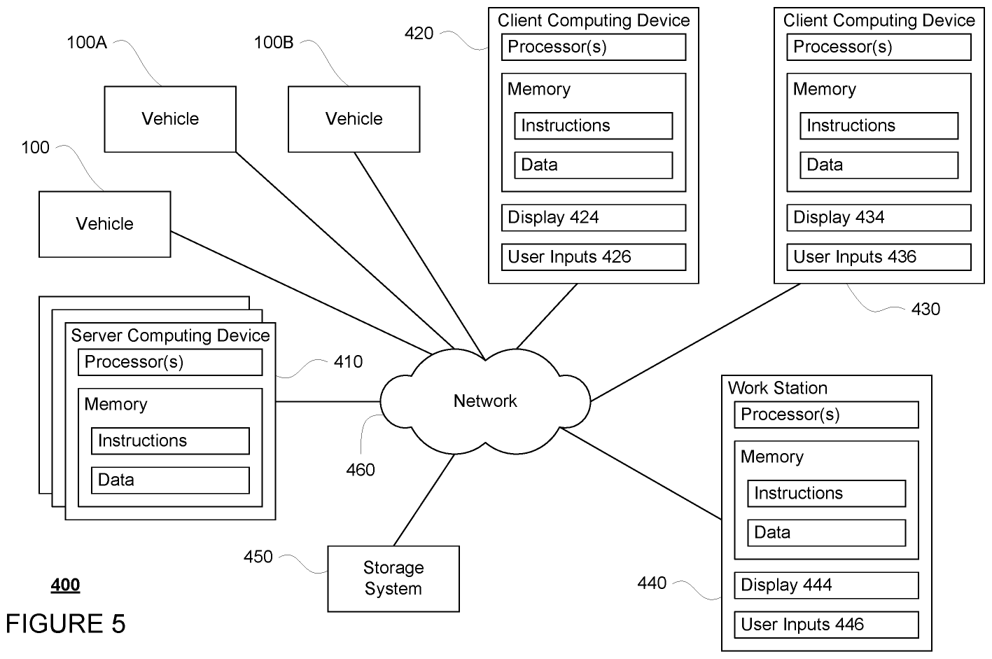

Computing device 110 of autonomous vehicle 100 may also receive or transfer information to and from other computing devices, such as those computing devices that are a part of the transportation service as well as other computing devices. FIGS. 4 and 5 are pictorial and functional diagrams, respectively, of an example system 400 that includes a plurality of computing devices 410, 420, 430, 440 and a storage system 450 connected via a network 460. System 400 also includes autonomous vehicle 100A and autonomous vehicle 100B, which may be configured the same as or similarly to autonomous vehicle 100. Although only a few vehicles and computing devices are depicted for simplicity, a typical system may include significantly more.

As shown in FIG. 5, each of computing devices 410, 420, 430, 440 may include one or more processors, memory, data and instructions. Such processors, memories, data and instructions may be configured similarly to one or more processors 120, memory 130, data 132, and instructions 134 of computing device 110.

The network 460, and intervening graph nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of autonomous vehicle 100 or a similar computing device of autonomous vehicle 100A or autonomous vehicle 100B as well as computing devices 420, 430, 440 via the network 460. For example, autonomous vehicles 100, 100A, 100B, may be a part of a fleet of vehicles that can be dispatched by server computing devices to various locations. In this regard, the server computing devices 410 may function as a scheduling system which can be used to arrange trips for passengers by assigning and dispatching vehicles such as autonomous vehicles 100, 100A, 100B. These assignments may include scheduling trips to different locations in order to pick up and drop off those passengers. In this regard, the server computing devices 410 may operate using scheduling system software in order to manage the aforementioned autonomous vehicle scheduling and dispatching. In addition, the computing devices 410 may use network 460 to transmit and present information to a user, such as user 422, 432, 442 on a display, such as displays 424, 434, 444 of computing devices 420, 430, 440. In this regard, computing devices 420, 430, 440 may be considered client computing devices.

As shown in FIG. 3, each client computing device 420, 430 may be a personal computing device intended for use by a user 422, 432 and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touch-screen, a projector, a television, or other device that is operable to display information), and user input devices 426, 436, 446 (e.g., a mouse, keyboard, touchscreen or microphone). The client computing devices may also include a camera for recording video streams, speakers, a network interface device, and all of the components used for connecting these elements to one another.

Although the client computing devices 420, 430 may each comprise a full-sized personal computing device, they may alternatively comprise mobile computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, such as a wristwatch as shown in FIG. 3. As an example, the user may input information using a small keyboard, a keypad, microphone, using visual signals with a camera, or a touch screen. As yet another example, client computing device 440 may be a desktop computing system including a keyboard, mouse, camera and other input devices.

In some examples, client computing device 420 may be a mobile phone used by a passenger of a vehicle. In other words, user 422 may represent a passenger. In addition, client computing device 430 may represent a smart watch for a passenger of a vehicle. In other words, user 432 may represent a passenger. The client computing device 440 may represent a workstation for an operations person, for example, a remote assistance operator or someone who may provide remote assistance to an autonomous vehicle and/or a passenger. In other words, user 442 may represent an operator (e.g., operations person) of a transportation service utilizing the autonomous vehicles 100, 100A, 100B. Although only a few passengers and operations persons are shown in FIGS. 4 and 5, any number of such passengers and remote assistance operators (as well as their respective client computing devices) may be included in a typical system.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 3 and 4, and/or may be directly connected to or incorporated into any of computing devices 110, 410, 420, 430, 440, etc. Storage system 450 may store various types of information which may be retrieved or otherwise accessed by a server computing device, such as one or more server computing devices 410, in order to perform some of the features described herein.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

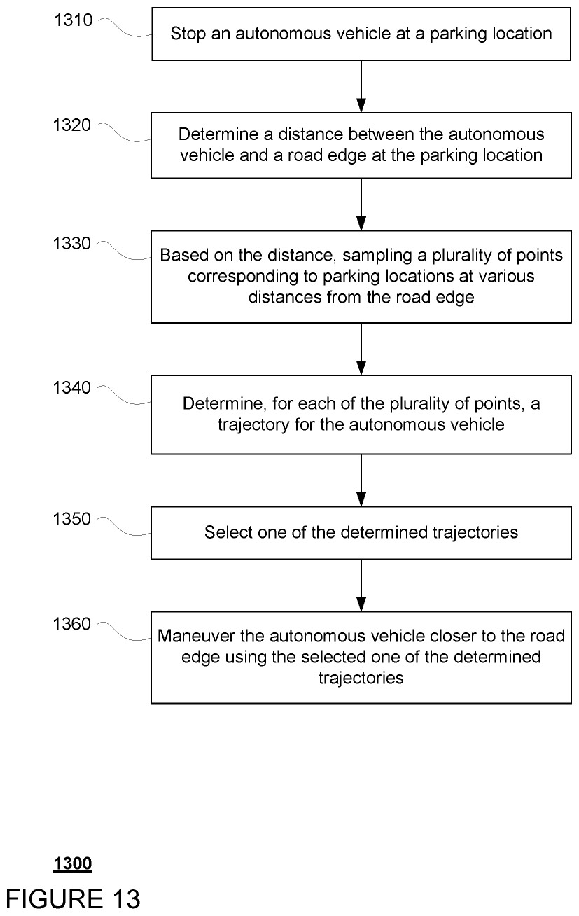

FIG. 13 is an example flow diagram 1300 for managing parking maneuvers of autonomous vehicle may be performed by one or more processors, such as the one or more processors of the forward planning system 168 and/or the one or more processors 120 of the computing devices 110 of autonomous vehicle 100 or other processors of the autonomous vehicle 100. At block 1310, an autonomous vehicle is stopped at a parking location.

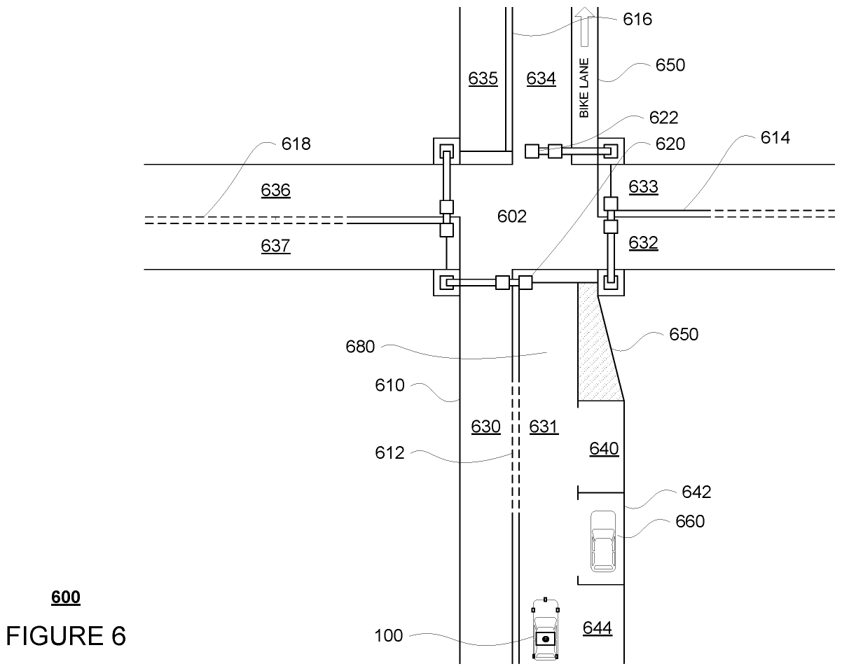

FIG. 6 depicts autonomous vehicle 100 in a geographic area 600 corresponding to the map information 200. In this example, intersection 602 corresponds to intersection 202, lane lines 610, 612, 614, 616, 618 correspond to lane lines 210, 212, 214, 216, 218, lanes 630, 631, 632, 633, 634, 635, 636, 637 correspond to lanes 230, 231, 232, 233, 234, 235, 236, 237, traffic signal lights 620, 622 correspond to traffic signal lights 220, 222, parking locations 640, 642, 644 correspond to parking locations 240, 242, 244, no parking zone 650 corresponds to no parking zone 250, and so on. Another vehicle 660 is currently stopped (e.g., parked) in parking location 642.

For instance, once the autonomous vehicle 100's computing devices 110 identify a parking location to pull over (e.g., a parking spot or other location), the forward planning system 168 may plan trajectories that cause the autonomous vehicle to pull into the parking location and stop the autonomous vehicle. For example, the autonomous vehicle 100 may stop at a parking location for any number of reasons, including to allow for entry and/or exit of passengers, loading and/or unloading of goods, etc. In this example, the computing devices 110 or forward planning system 168 may have identified parking location 640 as a location to stop and park the autonomous vehicle. This may be performed using any number of approaches; based on distance to current destination, ease of access, maneuvering capabilities of the autonomous vehicle, expected stopping time, etc.

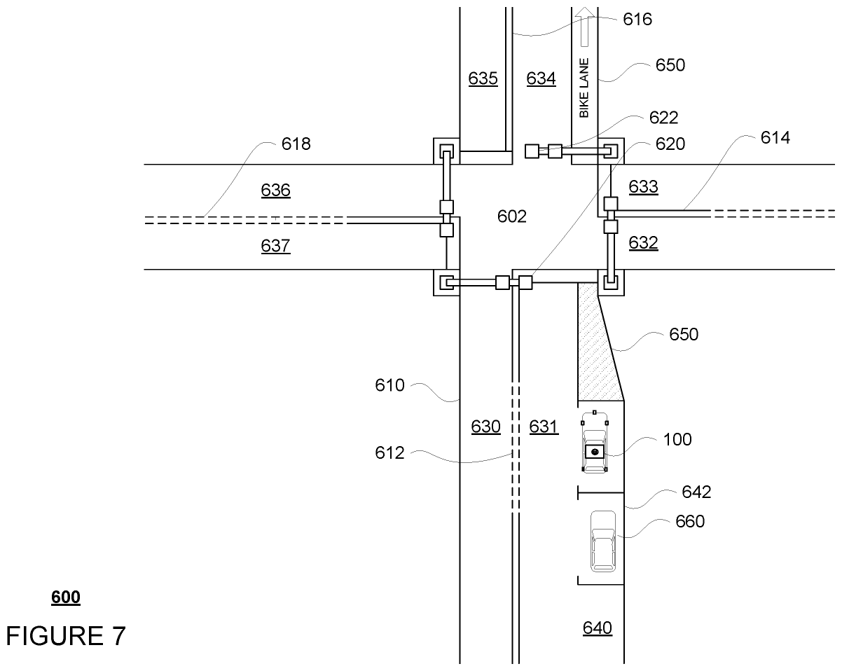

Thereafter, the autonomous vehicle 100 may have used the forward planning system to maneuver itself forward into the parking location 640, for instance, by setting the parking location 640 as a destination for the autonomous vehicle, planning and following trajectories accordingly. For example, as shown in FIG. 7, the autonomous vehicle has pulled forward around vehicle 660 and is stopped partially into the parking location 640. In this regard, the autonomous vehicle has not performed a parallel parking maneuver, but is at least partially in the parking location 640. However, as noted above, if the autonomous vehicle 100 is stopped to park and is too far from a road edge or curb, the forward planning system 168 may not be able to get closer unless it is able to plan trajectories that involve reversing maneuvers.

Returning to FIG. 13, at block 1320, a distance between the autonomous vehicle and a road edge at the parking location is determined. Once stopped, the computing devices 110 or forward planning system 168 may determine the distance between the autonomous vehicle 100 and the adjacent road edge. For example, the computing devices 110 or forward planning system 168 may receive information from the positioning system 172 and/or perception system 174. This information may be used to measure or determine relative distances between points on the autonomous vehicle and the road edge or curb. For example, the location of the road edge or curb may be determined in real time based on information from the perception system 174 and/or from information defined in the map information 200.

Alternatively, rather than waiting for the autonomous vehicle to be stopped, once the autonomous vehicle is within a predetermined distance of the pullover location (e.g., straight line distance or distance along a current trajectory or route), the forward planning system may generate a trajectory which causes the autonomous vehicle to stop at the pullover location. As an example, this predetermined distance may be 10 meters or more or less. Rather than controlling the autonomous vehicle to the pullover location and stopping, the computing devices 110 or forward planning system 168 may determine an expected distance between the autonomous vehicle and the road edge at the pullover location.

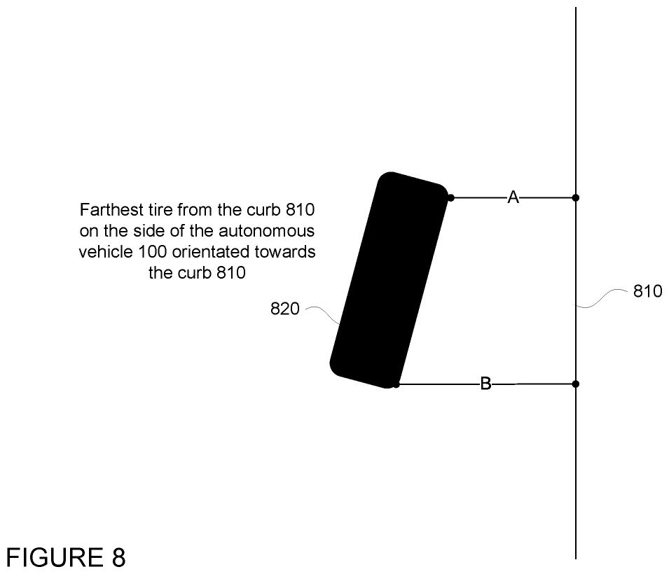

The distance to the road edge or curb may be defined as a distance between the road edge or curb and the farthest of the autonomous vehicle's tires on a side of the autonomous vehicle that is oriented towards or facing the road edge or curb (e.g., the right tires for right-hand parking situations, left tires for left-hand parking situations). Referring to FIG. 8, tire 820 represents a tire of the autonomous vehicle 100 on the side of the autonomous vehicle 100 that both farthest from the curb 810 (corresponding to the road edge for the parking location 640 where the autonomous vehicle 100 is stopped) and also oriented towards a curb 810. In one example, this distance may be measured as the closest distance between a reference point of the tire 820 of the autonomous vehicle 100 that is oriented towards the curb 810 and the curb 810 or distance A. In another example, this distance may be measured as the farthest distance between a reference point of the tire 820 of the autonomous vehicle 100 and the curb 810 corresponding to the road edge for the parking location 640 or distance B. The aforementioned reference points of the tire may be taken to be the curb-side edge of the tire at a point of contact with the ground.

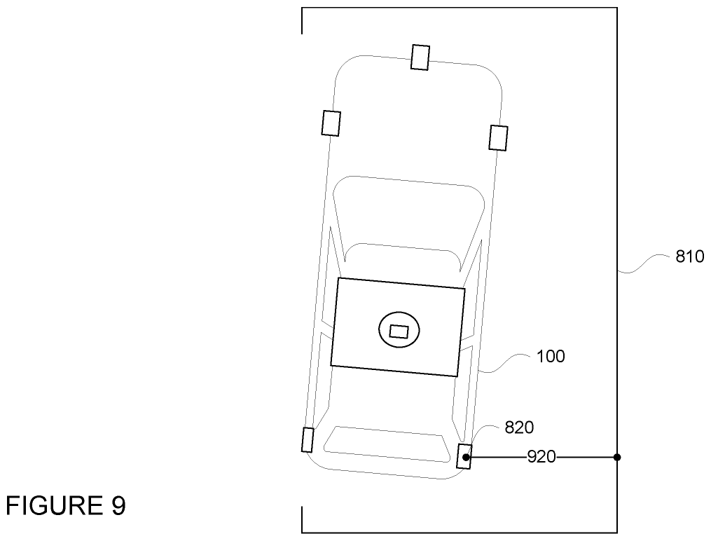

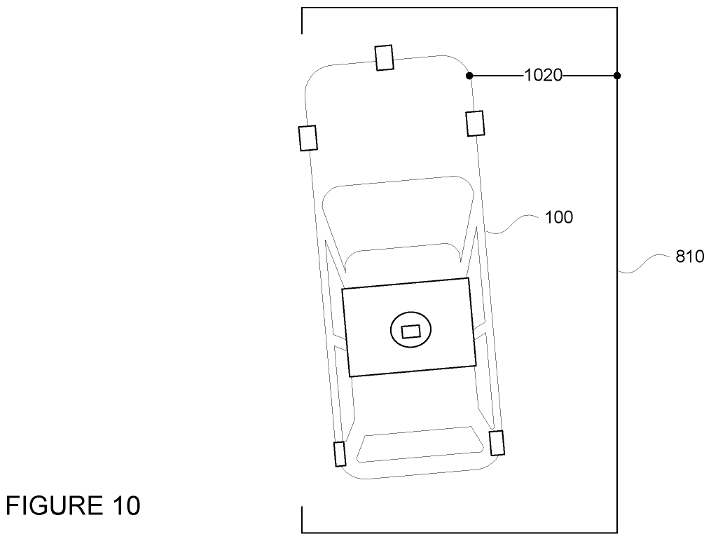

In this regard, if the autonomous vehicle is oriented slightly towards the road edge or curb (as depicted in FIG. 9), the distance to the road edge or curb would be the distance from the road edge or curb to a point on the autonomous vehicle's rear-right tire oriented towards the road edge or curb. At the same time, if the autonomous vehicle is oriented slightly towards the adjacent driving lane (as depicted in FIG. 10), the distance to the curb or road would be the distance from the road edge or curb to a point on the autonomous vehicle's front-right tire oriented toward the road edge or cub. FIGS. 9 and 10 provide example alternative detail views of autonomous vehicle 100 stopped adjacent (in different positions relative) to curb 810. In the example of FIG. 9, vehicle 100 is oriented slightly towards the road edge or curb 810. The furthest curb-side tire is the rear-right tire, and the distance to the curb is distance 920. In the example of FIG. 10, vehicle 100 is oriented slightly towards the adjacent driving lane (lane 631). The furthest curb-side tire is the front-right tire, and the distance to the curb is distance 1020. Returning to FIG. 13, at block 1330, based on the distance, the autonomous vehicle may be enabled to engage a set of planning behaviors that allow the autonomous vehicle to maneuver in reverse. If the autonomous vehicle 100 is within the threshold maximum distance, the autonomous vehicle may remain stopped in order to allow passengers to enter or exit, load or unload goods, etc. However, if the autonomous vehicle is not within the threshold maximum distance, the autonomous vehicle may attempt to maneuver itself closer to the road edge or curb. To do so, a set of planning behaviors may be engaged or unlocked in order to allow the forward planning system or maneuver planning system to plan trajectories that cause the autonomous vehicle to maneuver in reverse.

In this regard, the computing devices 110 or forward planning system 168 may determine whether the autonomous vehicle is within a threshold maximum distance of the curb (or road edge). The threshold may be a fixed value such as 6, 12, 18, 24 or more or less inches depending upon the desires of a transportation service to which the autonomous vehicle belongs, maneuvering capabilities of the autonomous vehicle or legal requirements (e.g., passenger vehicles must park within 6 inches, 12 inches, or 18 inches of a curb depending upon the local parking rules which may differ by jurisdiction, e.g., state to state). In some instances, this threshold maximum distance may be adjusted in real time based on the impact on other road users. For example, if the autonomous vehicle would be within legal requirements but farther than desired into an adjacent driving lane (which may impact other road users within the adjacent driving lane), the threshold value may be adjusted accordingly.

Returning to the examples of FIGS. 9 and 10, the distances 920, 1020 may be compared to the threshold maximum distance in order to determine whether these values meet the threshold maximum distance. If either distances are less than or equal to the maximum threshold value, the autonomous vehicle 100 may remain stopped. If these distances are less than the maximum threshold value, the set of planning behaviors may be engaged or unlocked in order to allow the forward planning system 168 or the maneuver planning system 169 to plan trajectories that cause the autonomous vehicle to maneuver in reverse.

In some instances, the forward planning system 168 may engage or “unlock” the set of planning behaviors in order to allow the forward planning system to plan trajectories that cause the autonomous vehicle to maneuver in reverse. In other instances, the maneuver planning system 169 may be utilized to maneuver the autonomous closer to a curb. In this regard, the maneuver planning system may engage in the aforementioned the set of planning behaviors, which may include, for example, maneuvering in reverse if needed. This may allow for a simplified system which can utilize different geometries (e.g., including those for reversing such as for multi-point turns or turning the autonomous vehicle's wheels while stationary), while at the same time requires much simpler “reasoning” or processing of time and speed as the maneuver planning system does not need to be capable of performing more complex maneuvers such as lane changes in traffic.

In some instances, in addition to determining whether the autonomous vehicle is within a threshold maximum distance of the curb (or road edge), in order to engage the set of planning behaviors, the computing system 110 and/or forward planning system 168 may determine whether the speed limit of the adjacent driving lane is at or below a threshold value. For example, the set of planning behaviors may only be engaged if the speed limit of the adjacent driving lane is less than or equal to 25 miles per hour or rather, may not be engaged if the speed limit of the adjacent driving lane is greater than 25 miles per hour. As noted above, this speed limit information may be incorporated into the map information or may alternatively be determined in real time by detecting and identifying speed limits of speed limit signs using computer vision, pattern or image matching, or other techniques. In other words, the autonomous vehicle may be effectively prevented from driving in reverse if parking adjacent to a lane with a speed limit over 25 miles per hour, while at the same time permitting the autonomous vehicle to drive in reverse if parking adjacent to a lane with a speed limit of 25 miles per hour. This may prevent the autonomous vehicle from planning trajectories which would cause the autonomous vehicle to drive in reverse on higher speed roads.

Returning to FIG. 13, at block 1330, Based on the distance, a plurality of points corresponding to parking locations is sampled at various distances from the road edge. In addition to the aforementioned, the set of planning behaviors may involve first sampling points corresponding to locations along the road edge or curb at various distances from the road edge or curb. For example, the sampled points may correspond to the final location of a center of a rear axle of the autonomous vehicle once the autonomous vehicle is stopped “at the location of the sampled point”. For example, the distances may range from a minimum value to the threshold maximum distance. The minimum value may be zero or may be defined based on the maneuvering capabilities of the autonomous vehicles. For example, the autonomous vehicle may not be capable of maneuvering the rear axle of the autonomous vehicle closer than 10 or 15 inches from the road edge or curb and thus, the minimum value may be 10 or 15 inches plus some conversion value based on the point on the autonomous vehicle. For instance, if the point on the autonomous vehicle is a center of the autonomous vehicle's rear axle, the conversion value may be a half-width of the autonomous vehicle measured at the center of the autonomous vehicle's rear axle. Thus, this conversion value may differ depending upon the specific dimensions of each specific autonomous vehicle.

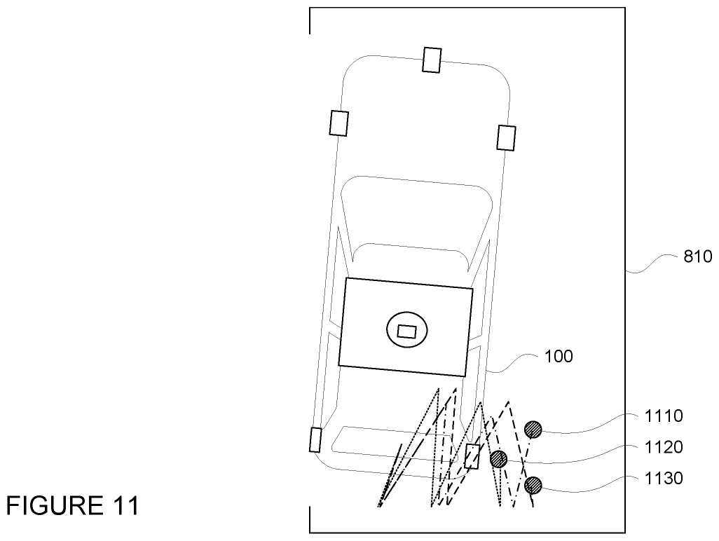

As an example, points may be sampled laterally relative to the road edge or curb at 1 inch or more or less and longitudinally relative to the road edge or curb at 10 centimeters or more or less. To limit the total number of sampled points, the computing devices need only sample points longitudinally up to a certain distance behind and ahead of the autonomous vehicle, which may also be limited based on information about the parking location, such as limits (e.g., boundaries) of an allowed parking area in which the parking location is located. For example, the sampling may start at 5 meters behind the current location of the autonomous vehicle's rear axle and end 5 meters ahead of the current location of the autonomous vehicle's rear axle. In this example, the maximum number of sampled points at each lateral distance may be 100 sampled points (e.g., 5 meters+5 meters=10 meters, 10 meters divided by 10 cm=100 sampled points). This number will increase depending on the number of distances sampled laterally from the road edge or curb. For example, if sampling every inch over 9 inches, the total sampled may be 900 sampled points (9 lateral distances×100 longitudinal sampled points=900 total sampled points). FIG. 11 provides an example representation of sampled points 1110, 1120, 1130 (represented as over-sized circles for ease of understanding) adjacent to the curb 810, only a few being depicted for simplicity.

In addition, any sampled points that would cause the autonomous vehicle to collide with or come too close to static or stationary obstacles such as other stopped vehicles, such as vehicle 660, or other geographical or map features which would make stopping in a particular area inappropriate (e.g., the end of a curb, no parking zones, or an intersection) may not be sampled or may be discarded. To do so, for each of the sampled points, the forward planning system may estimate where the outline of the autonomous vehicle (with or without some additional buffer area) would be located if the center of the rear axle is positioned at that sampled point and check to see whether the outline is in collision with any nearby obstacle. If so, such points may be discarded or not sampled.

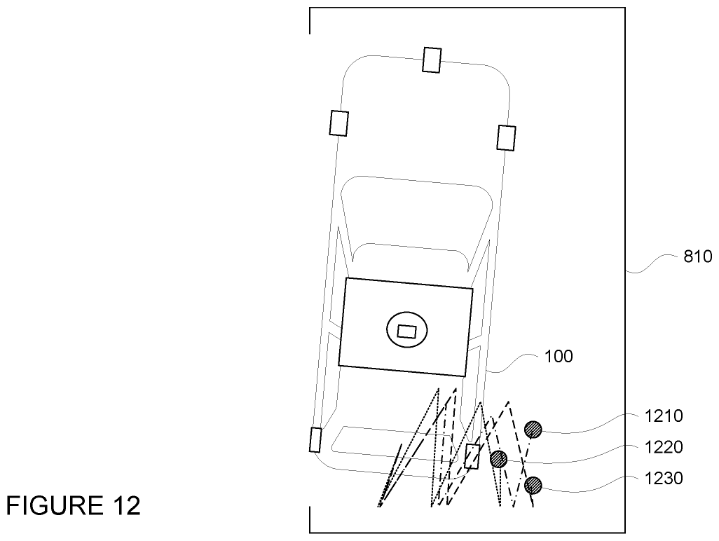

Returning to FIG. 13, at block 1340, for each of the plurality of points, a trajectory for the autonomous vehicle is determined. The locations of each of these sampled points may be input into the forward planning system 168 or maneuver planning system 169 as destinations in order to plan a trajectory for the autonomous vehicle to reach the locations of each of these sampled points. Other information, typically input into the forward planning system, such as the map information 200 as well as information generated by the perception system 174 may also be used. In addition, when available, the input map information may include information about the shape and location of the road edge or curb, nearby driving lanes, as well as information about parking locations, such as the limits of an allowed parking area as described above. The information or sensor data generated by the perception system may include, for example, static or stationary objects such as parked vehicles or vegetation which the autonomous vehicle should avoid. In addition, for the purposes of maneuvering closer to a road edge or curb, a route may not be required. FIG. 12 provides an example of trajectories 1210, 1220, 1230 to the locations of each of the sampled points 1110, 1120, 1130, respectively.

In addition to the constraints used to plan a trajectory for the forward planning system 168 typically, the set of planning behaviors may include additional constraints. For example, these additional constraints may be used to discourage the autonomous vehicle from driving too much into an adjacent driving lane. In this regard, the farther (distance) and the longer (time) the trajectory goes into the adjacent driving lane, the greater the cost of that trajectory. In some instances, the additional constraints may be hard constraints which effectively prevent the autonomous vehicle from pulling too far into the adjacent driving lane. For example, rather than assigning a higher cost, trajectories that extend more than a threshold distance (e.g. 3 meters or more or less or a distance to a start of an opposing lane of traffic) into the adjacent driving lanes relative to the road edge may be assigned an infinitely high cost or may simply be discarded. This may prevent the autonomous vehicle from selecting and following a trajectory that brings the autonomous vehicle into a lane with opposing traffic. In addition, or alternatively, the additional constraints may minimize the distance or amount of time that the autonomous vehicle is in reverse. In this regard, the farther (distance) and the longer (time) the trajectory has the autonomous vehicle driving in reverse, the greater the cost of that trajectory. Such additional constraints may thus improve safety of the autonomous vehicle's parking maneuvers.

Returning to FIG. 13, at block 1350, one of the determined trajectories is selected. As noted above, the forward planning system 168 or maneuver planning system 169 may therefore output a plurality of trajectories. As with typical planning approaches described above, the trajectory with the lowest overall cost may be selected by the forward planning system 168 or maneuver planning system 169 and published to the other systems of the autonomous vehicle in order to cause the autonomous vehicle to follow the selected trajectory. In this regard, the forward planning system 168 or maneuver planning system 169 may select one of the trajectories 1210, 1220, 1230.

In order to increase the likelihood that the autonomous vehicle 100 will be within a desired distance of the road edge or curb, an additional cost may be added to each trajectory based on the distance between the location of the corresponding sampled point for that trajectory and the road edge or curb. In this regard, this additional cost may increase (e.g., linearly, exponentially or otherwise) as the distance from the road edge or curb increases. In some instances, sampled points within a desired distance from the road edge or curb (e.g., sampled points within 6, 12, or 18 inches) may have zero cost or a small cost which increases linearly with distance from the road edge, and the additional cost for sampled points between the desired distance and the threshold maximum distance may increase in cost as described above. In this regard, the trajectory with the lowest cost may enable the autonomous vehicle to move closer to the road edge or curb.

At block 1360, the autonomous vehicle is maneuvered closer to the road edge using the selected one of the determined trajectories. The selected trajectory may be published to the other systems of the autonomous vehicle 100 in order to cause the autonomous vehicle to maneuver itself to the destination of the selected trajectory. The selected trajectory may be used to maneuver the autonomous vehicle 100 closer to the road edge or curb (e.g., curb 810). This trajectory may cause the autonomous vehicle to move forward and reverse multiple times as in a typical parallel parking maneuver or not at all. At the same time, the forward planning system 168 or maneuver planning system 169 may continue to use the set of planning behaviors to generate new trajectories for the autonomous vehicle to follow in order to reach the location of the selected sampled point. This may be especially important in situations in which a new obstacle, such as a pedestrian, bicyclist, or other vehicle, has moved near to the autonomous vehicle. In such instances, the forward planning system 168 or maneuver planning system 169 may only publish a new or updated trajectory if the new or updated trajectory has a cost which is significantly lower (e.g., a difference greater than a threshold value) than the current trajectory in order to avoid unnecessary switches between different trajectories. Once the location of the selected sampled point has been reached, the autonomous vehicle 100 may again be stopped to allow passengers to enter or exit, load or unload goods, etc. without further maneuvering in order to avoid any unnecessary delays. This may be especially important when the autonomous vehicle is stopping in locations where there is a limited time to stop and park (e.g., loading zones, airports, etc.). This may also involve engaging a parking brake, straightening the autonomous vehicle's wheels or orienting the wheels towards or away from the road edge or curb when parked downhill or uphill.

In some rare instances, no trajectory may be found that can get the autonomous vehicle 100 to any of the plurality of sampled points. For example, this may occur if there is an obstacle such as a garbage can or overgrown vegetation. In such instances, as with typical approaches, the computing devices 110 may send a signal via the network 460 to the computing device 440 in order to request assistance from a remote operator. In addition, or alternatively, the computing devices 110 may control the autonomous vehicle 100 to simply pull out of the parking location (if already stopped) and attempt to find and route the autonomous vehicle to a new parking location. In addition, the original parking location may be flagged in the map information as a location where autonomous vehicles of the fleet can never park or removed as a parking location from the map information. This may be performed locally by the computing devices 110, or based on a report from an autonomous vehicle of the fleet received by the server computing devices 410 and broadcast to the fleet in a map update. In this regard, each autonomous vehicle of the fleet may update its respective map information with the flag or by removing the parking location.

While the autonomous vehicle is stopped, the computing devices 110 and/or the planning system 168 may periodically check if the autonomous vehicle is able to maneuver out of the stopped location (e.g., even with the set of planning behaviors engaged), for example, if other vehicles pull nearby. In instances when the computing devices 110 and/or the planning system 168 determine that the autonomous vehicle is not able to maneuver out of the stopped location, the computing devices 110 may send a signal via the network 460 to the computing device 440 in order to request assistance from a remote operator. In some instances, the autonomous vehicle may then be automatically prevented from transporting passengers until the remote operator reviews the situation.

When the autonomous vehicle 100 is ready to pull out of the parking location, the forward planning system 168 (with the set of planning behaviors engaged) or maneuver planning system 169 may be used in order to allow the autonomous vehicle to reverse to exit the parking location. For instance, the forward planning system 168 or the maneuver planning system 169 may use the set of planning behaviors to generate trajectories in order to maneuver the autonomous vehicle to reach a route to a new destination. For instance, the new destination may be input into the routing system 170 which outputs a route. The forward planning system or maneuver planning system may select a nearby point on the route as an intermediate destination to which to maneuver the autonomous vehicle in order to reach the route and begin planning trajectories to the new destination. In some instances, the forward planning system 168 may provide the maneuver planning system 169 with the nearby point as a destination. This intermediate destination may be a specific location and orientation of the autonomous vehicle at some predetermined number of meters or feet forward.

Once the point along the route has been reached, the maneuver planning system 169 may automatically disengage and/or the set of planning behaviors may be locked or disengaged in order to allow the forward planning system 168 to resume generating trajectories and maneuver the autonomous vehicle forwards towards its ultimate destination. Alternatively, as soon as the forward planning system 168 is able to generate a trajectory and make forward progress towards the destination the forward planning system may again do so, automatically locking or disengaging the set of planning behaviors and/or disengaging the maneuver planning system by sending an additional instruction to the maneuver planning system.

Although the features herein are described in relation to a fully autonomous driving mode, all or some aspects of the disclosure may be used in conjunction with partially autonomous driving modes and/or manual driving models. For instance, once a driver has pulled at least partially into a location, the aforementioned features may be used to control the vehicle to a desired distance from a road edge or curb for an assisted parking maneuver.

The features described herein may allow for managing parking maneuvers for autonomous vehicles in certain situations, such as when an autonomous vehicle is not located within a desired distance of a road edge or curb. In such situations, the autonomous vehicle may enable or unlock a set of planning behaviors which allow the autonomous vehicle to maneuver closer to the road edge or curb which may require the autonomous vehicle to maneuver in reverse. By doing so, this may improve safety by reducing the amount of time the autonomous vehicle is within a driving lane adjacent to a location where the vehicle is attempting to stop. The approach described herein may allow the autonomous vehicle to initially pull forward into the location and avoid a typical parallel parking maneuver which requires the autonomous vehicle to stop completely in the driving lane adjacent to the location and then reverse into the location while at the same time minimize the time to complete a pullover in cases where no further maneuvering is required. Moreover, in situations in which the autonomous vehicle engages in a typical parallel parking maneuver, the autonomous vehicle may be able to pull into smaller pullover locations (e.g., between two other parked vehicles) and closer to the road edge.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only some of many possible embodiments. Further, the same reference numbers in different drawings can identify the same or similar elements.

1. A method comprising:
stopping, by one or more processors, an autonomous vehicle at a parking location;
determining, by the one or more processors, a distance between the autonomous vehicle and a road edge at the parking location;
based on the distance, sampling, by the one or more processors, a plurality of points corresponding to parking locations at various distances from the road edge;
determining, by the one or more processors, for each of the plurality of points, a trajectory for the autonomous vehicle;
selecting, by the one or more processors, one of the determined trajectories; and
maneuvering, by the one or more processors, the autonomous vehicle closer to the road edge using the selected one of the determined trajectories.

2. The method of claim 1, wherein determining the distance includes determining a farthest distance between the road edge and a tire of the autonomous vehicle that is (i) farthest from the road edge and (ii) on a side of the autonomous vehicle that is oriented towards the road edge.

3. The method of claim 1, wherein determining the determined trajectories is based on a comparison of the distance to a threshold maximum distance.

4. The method of claim 1, wherein the plurality of points is sampled from a minimum value from the road edge to a threshold maximum distance from the road edge.

5. The method of claim 1, further comprising enabling, by the one or more processors, the autonomous vehicle to engage a set of planning behaviors, and wherein the sampling is in response to engaging the set of planning behaviors.

6. The method of claim 5, wherein engaging the set of planning behaviors includes switching from a forward planning system of the autonomous vehicle to a maneuver planning system of the autonomous vehicle in order to determine the determined trajectories.

7. The method of claim 5, wherein engaging the set of planning behaviors includes enabling a forward planning system of the autonomous vehicle to plan trajectories that allow for maneuvers in reverse.

8. The method of claim 7, wherein the set of planning behaviors include constraints for reducing time spent in an adjacent driving lane.

9. The method of claim 7, wherein the set of planning behaviors include constraints for reducing distance maneuvered in an adjacent driving lane.

10. The method of claim 7, wherein the set of planning behaviors include constraints for reducing time spent maneuvering in reverse.

11. The method of claim 7, wherein the set of planning behaviors include constraints for reducing distance maneuvered in reverse.

12. The method of claim 1, further comprising, determining for each determined trajectory a cost based at least in part on a shortest distance between the road edge and a point of the plurality of points for the determined trajectory, and wherein the selecting the one of the determined trajectories is based on the determined costs.

13. The method of claim 12, wherein determining the cost for each determined trajectory is based on expected time spent in an adjacent driving lane.

14. The method of claim 12, wherein determining the cost for each determined trajectory is based on expected time spent maneuvering in reverse.

15. The method of claim 12, wherein determining the cost for each determined trajectory is based on expected distance driven in an adjacent driving lane.

16. The method of claim 12, wherein determining the cost for each determined trajectory is based on expected distance driven in reverse.

17. The method of claim 12, wherein determining the cost for each determined trajectory is based on whether that determined trajectory extends more than a threshold distance into an adjacent driving lane.

18. The method of claim 1, further comprising, discarding a second of the determined trajectories from the determined trajectories based on whether the second of the determined trajectories extends more than a threshold distance into an adjacent driving lane.

19. A system comprising:
one or more processors configured to:
stop an autonomous vehicle at a parking location;
determine a distance between the autonomous vehicle and a road edge at the parking location;
based on the distance, sample a plurality of points corresponding to parking locations at various distances from the road edge;
determine for each of the plurality of points, a trajectory for the autonomous vehicle;
select one of the determined trajectories; and
maneuver the autonomous vehicle closer to the road edge using the selected one of the determined trajectories.

20. The system of claim 19, further comprising the vehicle.
